(19) United States
(12) Patent Application Publication
(10) Pub. No.: US 2014/0202005 A1
(43) Pub. Date: Jul. 24, 2014

(54) FRUIT TOOL

(71) Applicant: John Louis Schoeman, Mona Vale (AU)

(72) Inventor: John Louis Schoeman, Mona Vale (AU)

(21) Appl. No.: 13/744,652

(22) Filed: Jan. 18, 2013

(51) Int. Cl. A47J 25/00

(52) U.S. Cl. CPC A47J 25/00
USPC 30/113.3

(57) ABSTRACT

Various embodiments of a fruit tool apparatus and methods of use of a fruit tool apparatus are disclosed.

### BACKGROUND

The preparation of fruits often requires the use of multiple utensils. For example, preparing fleshy fruits having a hard pit may require a use of a knife to open the fruit, a scoop or spoon to remove the pit, a knife to slice the fruit, and a masher to mash the fruit.

What is needed is a single utensil to prepare fruits having a hard pit.

### SUMMARY

In one embodiment, a fruit tool is provided, the fruit tool comprising: a handle; a blade extending from the handle in a first direction, wherein the blade comprises a crescent-shaped profile with an arcuate interior edge and an arcuate exterior edge, wherein the exterior edge is sharpened and configured to puncture a skin of a fruit, wherein the interior edge comprises at least one first spike extending from the interior edge toward the handle; and a scoop extending from the handle in a second direction, wherein the scoop comprises a substantially arcuate profile.

In another embodiment, a fruit tool is provided, the fruit tool comprising: a handle; a blade extending from the handle in a first direction, wherein the blade comprises a crescent-shaped profile with an arcuate interior edge and an arcuate exterior edge, wherein the exterior edge is sharpened and configured to puncture a skin of a fruit, wherein the interior edge comprises at least one first spike extending from the interior edge toward the handle; and at least one second spike slidably connected to the handle extending from the handle toward the interior edge, wherein the at least one second spike is configured to translate toward the at least one first spike, and wherein the at least one second spike and the at least one first spike are configured to engage the pit portion of a fruit.

In another embodiment, a fruit tool is provided, the fruit tool comprising: a handle; a blade extending from the handle in a first direction, wherein the blade comprises a crescent-shaped profile with an arcuate interior edge and an arcuate exterior edge, wherein the exterior edge is sharpened and configured to puncture a skin of a fruit, wherein the interior edge comprises at least one first spike extending from the interior edge toward the handle; at least one second spike slidably connected to the handle extending from the handle toward the interior edge, wherein the at least one second spike is configured to translate toward the at least one first spike, wherein the at least one second spike and the at least one first spike are configured to engage the pit portion of a fruit; and a scoop extending from the handle in a second direction, wherein the scoop comprises a substantially arcuate profile.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a top perspective view of an example arrangement of a fruit tool.

FIG. 2 illustrates a bottom perspective view of an example arrangement of a fruit tool.

FIG. 3 illustrates a top perspective view of an example arrangement of a fruit tool.

FIG. 4 illustrates a bottom perspective view of an example arrangement of a fruit tool.

### DETAILED DESCRIPTION

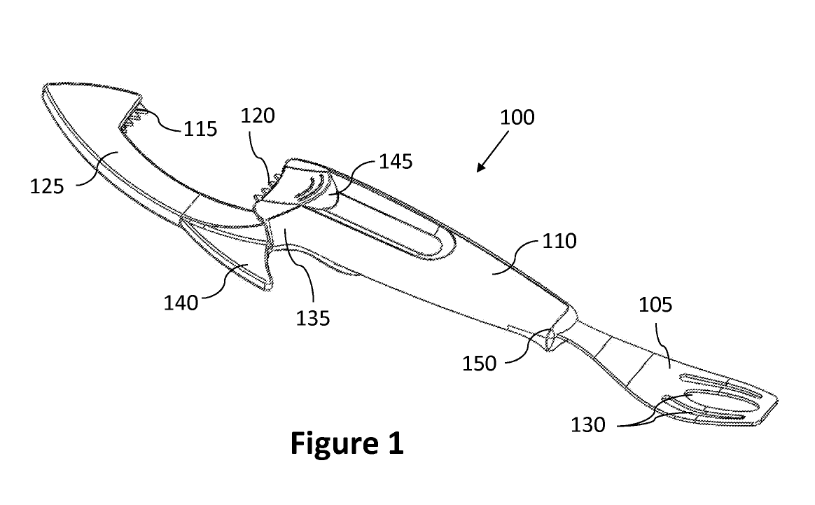

FIG. 1 illustrates a top perspective view of an example arrangement of a fruit tool 100 including a scoop 105, a handle 110, at least one first spike 115, at least one second spike 120, and a removable cover 125.

Fruit tool 100 may be used for preparation of any fleshy fruit including a hard pit. In one embodiment, fruit tool 100 is configured to be used in the preparation of an avocado. In one embodiment, fruit tool 100 may be shaped so as to resemble a shark.

Scoop 105 may comprise any of a polymer, a wood, and a metal. Scoop 105 may comprise at least one recess 130 comprising a portion of material removed from scoop 105. In one embodiment, at least one recess 130 aids in removing fruit from scoop 105, such that the fruit does not stick to recess 130 portions of scoop 105. In one embodiment, scoop 105 is configured to be used to mash a fruit, including for example avocado fruit. At least one recess 130 of scoop 105 may be configured to allow the fruit to extend through scoop 105 thereby assisting in breaking up of the fruit during mashing.

In one embodiment, scoop 105 comprises a substantially arcuate profile. Scoop 105 may comprise an arcuate profile to assist in using scoop 105 for scooping a fruit from within the fruit's shell, such as for example an avocado. In one embodiment, scoop 105 is varied in thickness, including a thin portion along a first edge and an increased thickness moving away from the first edge. In one embodiment, the first edge is the edge distally oriented relative to handle 110.

Handle 110 may comprise any of a polymer, a wood, and a metal. In one embodiment, handle 110 is configured to be gripped by a human hand, and is as such ergonomically correct. Handle 110 may comprise a grip or texture (not shown) to aid in gripping handle 110. In one embodiment, handle 110 includes a hilt portion 135 configured to assist in the prevention of a user's hand sliding forward of handle 110.

Fruit tool 100 may comprise at least one first spike 115. At least one first spike 115 may comprise any of a polymer, a wood, and a metal. At least one first spike 115 may comprise a plurality of spikes oriented at least substantially linearly. In another embodiment, at least one first spike 115 comprises any number of spikes oriented in any given manner in a surface opposed to handle 110.

Fruit tool 100 may comprise at least one second spike 120. At least one second spike 120 may comprise any of a polymer, a wood, and a metal. At least one second spike 120 may comprise a plurality of spikes oriented at least substantially linearly. In another embodiment, at least one second spike 120 comprises any number of spikes oriented in any given manner in a surface opposed to at least one first spike 115.

In one embodiment, either of at least one first spike 115 and at least one second spike 120 is configured to effectively grip the pit of a fruit, including for example an avocado pit. In another embodiment, either of at least one first spike 115 and at least one second spike 120 is configured to at least partially penetrate the exterior of a pit of a fruit, including for example an avocado pit.

Removable cover 125 may approximate the shape of a blade (not shown) extending out of handle 110. In one embodiment, removable cover comprises a tab portion 140 configured to permit a user to push removable cover 125 from fruit tool 100 while gripping handle 110. In another embodiment, tab 140 approximates the fin of a shark.

In one embodiment, fruit tool 100 comprises a slide 145, wherein at least one second spike 120 is connected to slide 145. Slide 145 may be configured to translate longitudinally along handle 110 of fruit tool 100. In one embodiment, slide 145 is contained within a channel in handle 110 such that slide 145 cannot move with the exception of longitudinal translation. In this manner, slide 145 and accordingly at least one second spike 120 may be extended away from handle 110 and closer to at least one first spike 115. In practice, a user may extend slide 145 while capturing the pit of a fruit between at least one first spike 115 and at least one second spike 120. Accordingly, at least one first spike 115 and at least one second spike 120 may engage the pit so that the pit may be removed from the fruit. In one embodiment, slide 145 is configured to be actuated by the finger of a user.

In one embodiment, fruit tool 100 comprises at least one mechanical detent operatively connected to slide 145, and configured to selectively maintain slide 145 and at least one second spike 120 in at least one of an extended position (nearer at least one first spike 115) and a retracted position (nearer handle 110).

In one embodiment, handle 110 comprises a protrusion 150 adjacent to scoop 105, wherein protrusion 150 is configured to prevent a user's hand from accidentally sliding from handle 110 and onto scoop 105. In another embodiment, protrusion 150 is configured to elevate scoop 105 from a surface upon which fruit tool 100 may be placed. Protrusion 150 may be configured to keep residue from a fruit left on scoop 105 from transferring to a surface such as a counter top.

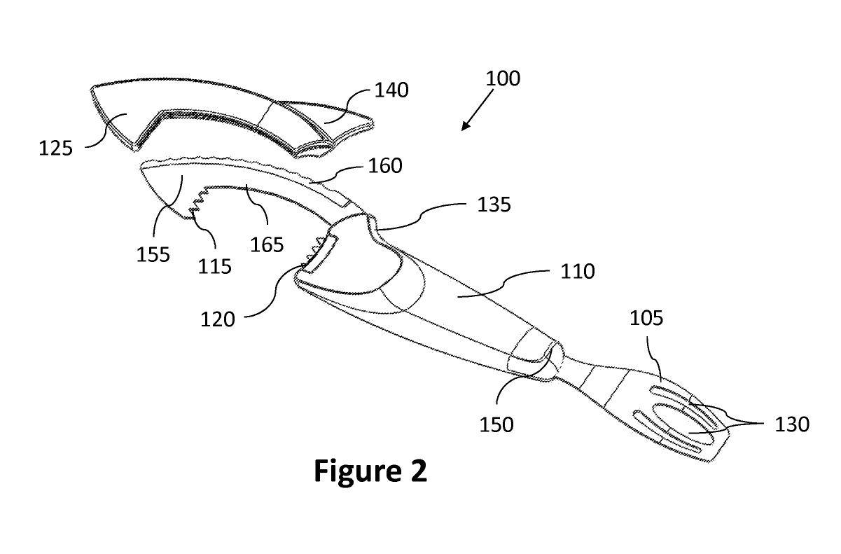

FIG. 2 illustrates a bottom perspective view of an example arrangement of fruit tool 100 including a scoop 105, a handle 110, at least one first spike 115, at least one second spike 120, and a removable cover 125.

As illustrated in FIG. 2, removable cover 125 may be removed from fruit tool 100 to reveal a blade 155. Blade 155 may comprise any of a polymer, a wood, and a metal. Blade 155 may comprise a crescent-shaped profile with an arcuate exterior edge 160 and an arcuate interior edge 165. In one embodiment, exterior edge 160 and interior edge 165 are oppositely oriented.

In one embodiment, exterior edge 160 is sharpened. In another embodiment, exterior edge 160 comprises at least one serration. In another embodiment, exterior edge 160 is substantially entirely serrated. In another embodiment, exterior edge 160 is configured to puncture a skin of a fruit, including for example an avocado. Removable cover 125 may be configured to at least partially encompass at least exterior edge 160 so as to prevent a user from accidentally coming into contact with a sharpened portion of fruit tool 100 when fruit tool 100 is not in use. In one embodiment, handle 110 comprises a hilt 135 adjacent to blade 155, and configured to prevent a user's hand from accidentally sliding off handle 110 and onto exterior edge 160.

Interior edge 165 may comprise at least one first spike 115, extending from interior edge 165 toward handle 110. In one embodiment, at least one second spike 120 may be slidably connected to handle 110 and extending from handle 110 toward interior edge 165. At least one second spike 120 may be configured to translate toward at least one first spike 115.

In one embodiment, handle 110 is integrally formed about blade 155 and scoop 105. In another embodiment, handle 110 is formed by at least one of co-molding or overmolding. In another embodiment, handle 110 is removably connected to at least one of blade 155 and scoop 105. In one embodiment, scoop 105 and blade 155 are integrally connected to one another. In another embodiment, scoop 105 and blade 155 are removably connected to one another.

In one embodiment, fruit tool 100 comprises handle 110 with blade 155 extending from handle 110 in a first direction and scoop 105 extending from handle 110 in a second direction.

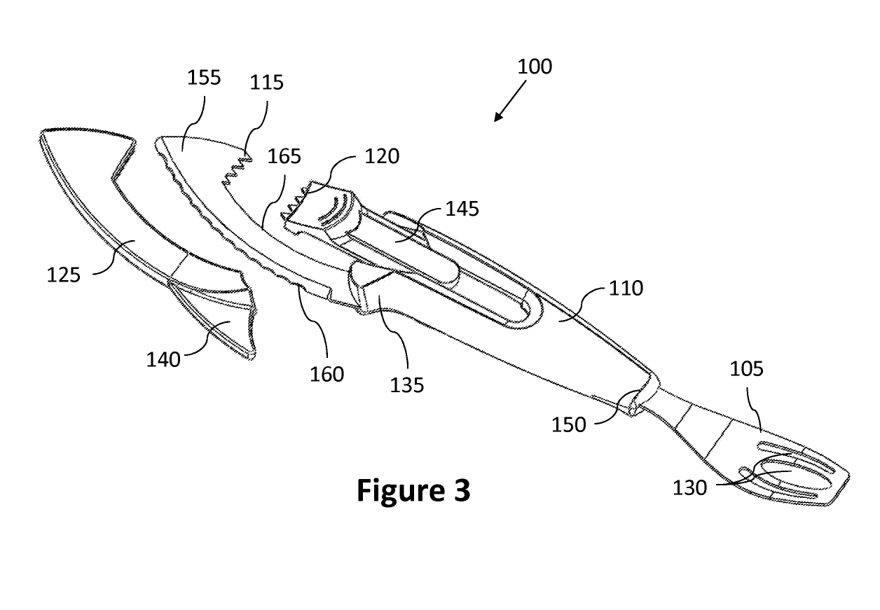

FIG. 3 illustrates a top perspective view of an example arrangement of fruit tool 100 including a scoop 105, a handle 110, at least one first spike 115, at least one second spike 120, and a removable cover 125. Fruit tool 100 may include slider 145 comprising at least one second spike 120, and blade 155 comprising interior edge 165 including at least one first spike 115. Slider 145 and at least one second spike 120 may be extended longitudinally from handle 110 toward interior edge 165 and at least one first spike 115. Fruit tool 100 may be utilized to engage and remove the pit from a fruit, wherein the fruit is halved and the pit is exposed. In one embodiment, the fruit is an avocado.

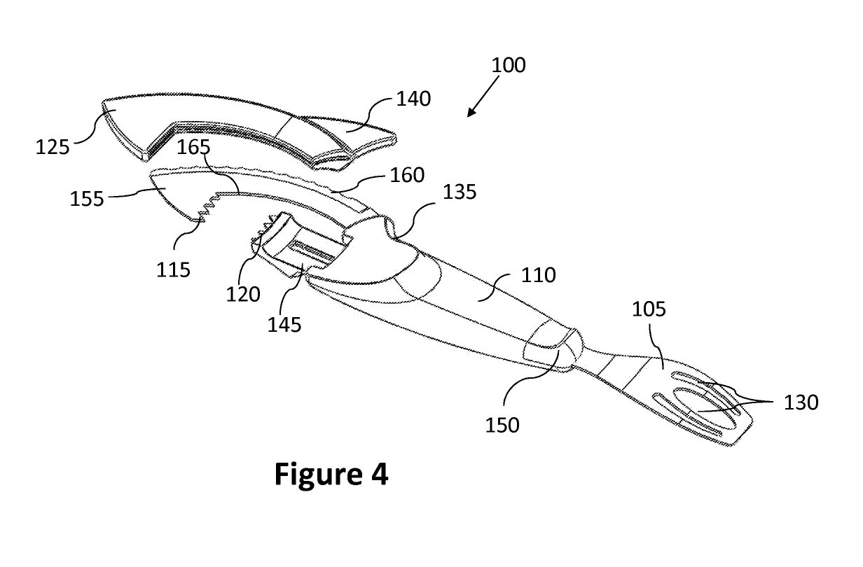

FIG. 4 illustrates a bottom perspective view of an example arrangement of fruit tool 100 including a scoop 105, a handle 110, at least one first spike 115, at least one second spike 120, and a removable cover 125. Fruit tool 100 may include slider 145 comprising at least one second spike 120, and blade 155 comprising interior edge 165 including at least one first spike 115. Slider 145 and at least one second spike 120 may be extended longitudinally from handle 110 toward interior edge 165 and at least one first spike 115. Fruit tool 100 may be utilized to engage and remove the pit from a fruit, wherein the fruit is halved and the pit is exposed. In one embodiment, the fruit is an avocado.

In practice, fruit tool 100 may be used to process a fleshy fruit having a hard pit. For example, fruit tool 100 may be used to process an avocado. In one embodiment, removable cover 125 is removed to reveal blade 155. Blade 155 may comprise a serrated exterior edge 160. A user may grasp handle 110 and use blade 155 to puncture and slice through the skin of the avocado, without cutting into its hard pit. Blade 155 may be used to slice equatorially about the entire thickness of the avocado, which avocado can be split into two halves. Half of the avocado will contain the hard pit, which may be removed by engaging the pit between at least one first spike 115 and at least one second spike 120. Extending at least one second spike 120 via slider 145 to engage the pit allows a user to pull the pit from the avocado. The user may now optionally utilize the blade portion to slice the interior flesh of the avocado into slices. The user may optionally utilize scoop 105 to remove the interior flesh of the avocado. The user may optionally utilize scoop 105 as a masher to mash the interior flesh of the avocado.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A fruit tool comprising:
a handle;
a blade extending from the handle in a first direction,
wherein the blade comprises a crescent-shaped profile with an arcuate interior edge and an arcuate exterior edge,
wherein the exterior edge is sharpened and configured to puncture a skin of a fruit,
wherein the interior edge comprises at least one first spike extending from the interior edge toward the handle; and
a scoop extending from the handle in a second direction,
wherein the scoop comprises a substantially arcuate profile.

2. The fruit tool of claim 1, further comprising a removable cover configured to at least partially encompass the exterior edge of the blade.

3. The fruit tool of claim 1, wherein the handle comprises a hilt portion adjacent to the blade.

4. The fruit tool of claim 1, wherein the scoop is varied in thickness, including a thin portion along a first edge and an increased thickness moving away from the first edge.

5. The fruit tool of claim 1, wherein the handle comprises protrusion adjacent to the scoop.

6. The fruit tool of claim 1, wherein the handle is integrally formed about the blade and the scoop.

7. The fruit tool of claim 6, wherein the handle is formed by at least one of co- molding or overmolding.

8. The fruit tool of claim 1, wherein the handle comprises at least one of a polymer, a wood, and a metal.

9. The fruit tool of claim 1, wherein the blade comprises at least one of a polymer, a wood, and a metal.

10. The fruit tool of claim 1, wherein the scoop comprises at least one of a polymer, a wood, and a metal.

11. The fruit tool of claim 1, wherein the scoop comprises at least one recess.

12. The fruit tool of claim 1, wherein the exterior edge comprises at least one serration.

13. A fruit tool comprising:
a handle;
a blade extending from the handle in a first direction,
wherein the blade comprises a crescent-shaped profile with an arcuate interior edge and an arcuate exterior edge,
wherein the exterior edge is sharpened and configured to puncture a skin of a fruit,
wherein the interior edge comprises at least one first spike extending from the interior edge toward the handle; and
at least one second spike slidably connected to the handle extending from the handle toward the interior edge,
wherein the at least one second spike is configured to translate toward the at least one first spike, and
wherein the at least one second spike and the at least one first spike are configured to engage the pit portion of a fruit.

14. The fruit tool of claim 13, wherein the at least one second spike is connected to a slide configured to be actuated by the finger of a user.

15. The fruit tool of claim 13, further comprising at least one mechanical detent along the translation of the at least one second spike, wherein the at least one mechanical detent is configured to selectively retain the at least one second spike in at least one of a retracted position and an extended position.

16. The fruit tool of claim 13, wherein the handle comprises at least one of a polymer, a wood, and a metal.

17. The fruit tool of claim 13, further comprising a scoop extending from the handle in a second direction.

18. A fruit tool comprising:
a handle;
a blade extending from the handle in a first direction,
wherein the blade comprises a crescent-shaped profile with an arcuate interior edge and an arcuate exterior edge,
wherein the exterior edge is sharpened and configured to puncture a skin of a fruit,
wherein the interior edge comprises at least one first spike extending from the interior edge toward the handle;
at least one second spike slidably connected to the handle extending from the handle toward the interior edge,
wherein the at least one second spike is configured to translate toward the at least one first spike,
wherein the at least one second spike and the at least one first spike are configured to engage the pit portion of a fruit; and
a scoop extending from the handle in a second direction,
wherein the scoop comprises a substantially arcuate profile.

19. The fruit tool of claim 18, wherein the handle comprises at least one of a polymer, a wood, and a metal.

20. The fruit tool of claim 18, wherein the blade and the scoop comprise at least one of a polymer, a wood, and a metal.
